(19) United States
(12) Patent Application Publication
(10) Pub. No.: US 2012/0137085 A1
(43) Pub. Date: May 31, 2012

(54) COMPUTER SYSTEM AND ITS CONTROL METHOD

(75) Inventors: Natsumi Kaneta, Odawara (JP); Yoshihisa Honda, Odawara (JP); Satoshi Saito, Odawara (JP)

(73) Assignee: Hitachi, Ltd.

(21) Appl. No.: 12/996,723

(22) PCT Filed: Nov. 25, 2010
(86) PCT No.: PCT/JP2010/006885

§ 371 Date: Dec. 7, 2010

(51) Int. Cl. G06F 12/02

(52) U.S. Cl. 711/154; 711/E12.002

(57) ABSTRACT

Provided is a computer system capable of migrating processing authority for accessing a logical volume between multiple storage apparatuses without causing any overhead in the performance of the path between the multiple storage apparatuses.

Upon migrating processing authority of a processor for accessing a logical volume to be accessed by a host computer between the multiple storage apparatuses, the computer system copies data of a logical volume of a migration source storage apparatus to a logical volume of a migration destination storage apparatus, and changes a path to and from the host computer from the migration source storage apparatus to the migration destination storage apparatus.

### TECHNICAL FIELD

The present invention relates to a computer system, and particularly relates to a computer system in which a host computer is connected to a system to which a plurality of storage apparatuses are coupled, and to its control method.

### BACKGROUND ART

As this type of computer system, known is a storage system comprising a host computer, and a storage apparatus for providing a large-capacity storage resource to the host computer. The storage apparatus comprises a storage controller for processing the read or write access from the host computer to the logical volume set in the storage resource.

The storage controller is usually provided by comprising a plurality of microprocessors (MP) for efficiently processing the access from the host computer. When the storage controller receives a read or write access from the host computer, it determines the microprocessor to be in charge of the processing of the access target logical volume based on a mapping table, and causes the determined microprocessor to execute the write or read processing.

The storage controller balances the load among the plurality of microprocessors by dynamically changing the correspondence relation of the logical volume and the microprocessor to process the I/O to the logical volume according to the load status of the microprocessor. As conventional technology based on the foregoing perspective, there is the storage system described, for example, in Japanese Patent Application Publication No. 2008-269424A.

With this storage system, the host I/F unit includes a management table for managing the MP in charge of controlling the I/O processing to a storage area of the LDEV (logical volume), and, when there is an I/O request from a host computer to be performed to the LDEV, delivers the I/O request to the MP in charge of the I/O processing of the LDEV based on the management table. The MP performs the I/O processing based on the I/O request, and the MP further determines whether to change the association of the I/O processing to the LDEV to another MP. If the host I/F unit determines that the MP should be changed, it sets the management table so that an MP that is different from the current associated MP will be in charge of the I/O processing to be performed to the LDEV.

### CITATION LIST

### Patent Literature

[PTL 1] Japanese Patent Application Publication No. 2008-269424A

### SUMMARY OF INVENTION

### Technical Problem

From the perspective of providing redundancy and a large-capacity storage resource to the host computer, there is a system which connects a plurality of storage apparatuses and unifies the management thereof. With this system, it is recommended that the processing authority, or owner right, of the MP for accessing the logical volume be migrated between the plurality of storage apparatuses in order to balance the load of the MP at a higher level.

Nevertheless, if the owner right for accessing the logical volume is migrated to an MP of a separate case from the storage apparatus including the logical volume, since the migration destination MP needs to access the logical volume of a migration source storage apparatus across the connection between a plurality of cases, overhead will arise in the path performance between the plurality of storage apparatuses, and there is a possibility that the processing performance of the I/O from the host computer will deteriorate.

Thus, an object of this invention is to provide a computer system capable of migrating processing authority for accessing a logical volume between a plurality of storage apparatuses without causing any overhead in the performance of the path between the plurality of storage apparatuses, and its control method.

### Solution to Problem

In order to achieve the foregoing object, the present invention is characterized in that, upon migrating processing authority of a processor for accessing a logical volume to be accessed by a host computer between the multiple storage apparatuses, data of a logical volume of a migration source storage apparatus is copied to a logical volume of a migration destination storage apparatus, and a path to and from the host computer is changed from the migration source storage apparatus to the migration destination storage apparatus.

According to the foregoing configuration, the processor to which the processing authority to the logical volume was migrated will be able to process the access from the host computer to the logical volume of its self-case without having to go through a path between storage apparatuses.

### Advantageous Effects of Invention

As explained above, according to the present invention, it is possible to provide a computer system capable of migrating processing authority for accessing a logical volume between a plurality of storage apparatuses without causing any overhead in the performance of the path between the plurality of storage apparatuses, and its control method.

### BRIEF DESCRIPTION OF DRAWINGS

FIG. 1 is a block diagram of the computer system according to the first embodiment.

FIG. 2 is a block diagram showing a state where an I/O from the server is being issued to the first storage apparatus.

FIG. 3 is a block diagram showing a state where the owner right for accessing the logical volume is being switched from the microprocessor of the first storage apparatus to the microprocessor of the second storage apparatus.

FIG. 4 is a block diagram showing a state of copying the first volume of the first storage apparatus to the second volume of the second storage apparatus, and switching the path between the host computer and the first volume to the path between the host computer and the second volume in the system depicted in FIG. 3.

FIG. 5 is a block diagram of the management computer (SVP) provided in the storage apparatus.

FIG. 6 is an example of the LDEV management table.

FIG. 7 is an example of the MP management table.

FIG. 8 is an example of the port management table.

FIG. 9 is an example of the mapping table recorded in the local memory of the CHA.

FIG. 10 is a flowchart of the control processing to be performed to the microprocessor which routes the I/O to the storage apparatus of the host computer.

FIG. 11 is a detailed flowchart of the volume copy processing.

FIG. 12 is a flowchart of the path change processing.

FIG. 13 is a flowchart of the path control software of the server.

FIG. 14 is an example of the path management table.

FIG. 15 is a block diagram of the computer system according to the second embodiment.

FIG. 16 is an example of the LDEV performance information table for managing the I/O performance of the business server to the LDEV.

FIG. 17 is an example of the requirement table which sets forth the requirements of the I/O performance in the application.

FIG. 18 is a flowchart of the volume migration management program to be executed by the management server.

FIG. 19A is a block diagram of a plurality of microprocessors in the first storage apparatus and the second storage apparatus.

FIG. 19B is a graph showing the fluctuation in the (weekly) operating ratio of the respective microprocessors.

FIG. 20 is a table for managing the implementation history of volume copy.

### DESCRIPTION OF EMBODIMENTS

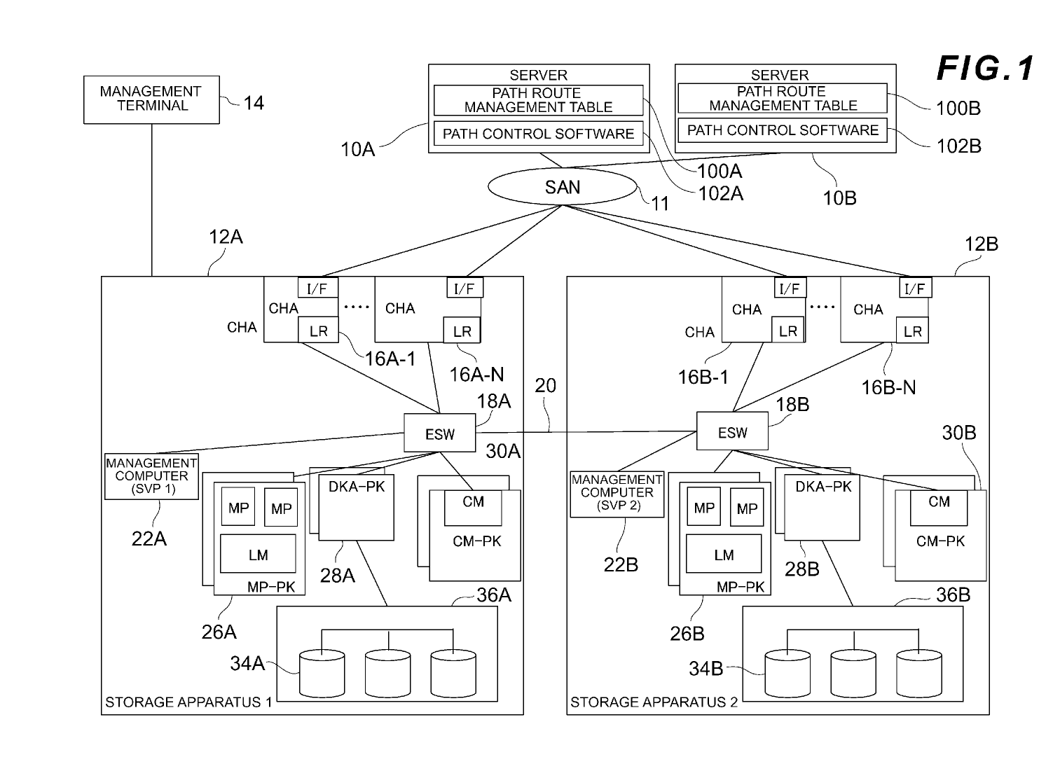

The first embodiment of the computer system according to the present invention is now explained. The computer system comprises, as shown in FIG. 1, a plurality of servers 10A, 10B as a host computer, and a plurality of storage apparatuses 12A, 12B for providing a storage resource to the plurality of servers. Each storage apparatus sets an LDEV (logical volume) to the storage resource, and the server achieves the read/write processing by accessing the LDEV. A management computer (SVP) 22A, 22B of the storage apparatus is used for controlling and managing the owner right of the processing for accessing the LDEV to be accessed by the server, and the logical path between the server and the LDEV.

Details of the computer system are now explained with reference to FIG. 1. FIG. 1 is a block diagram of the computer system according to the first embodiment. The first server 10A and the second server 10B are respectively connected to the storage apparatus via a network 11 such as a SAN. The storage apparatus is configured from a first storage apparatus 12A and a second storage apparatus 12B, and a dedicated bus configured from a dedicated interface such as PCI Express is set between the first storage apparatus 12A and the second storage apparatus 12B.

Accordingly, the two storage apparatuses 12A, 12B configure a tight coupling-type cluster storage, and the two storage apparatuses 12A, 12B are able to behave as a single storage apparatus to the server by sharing various control resources, storage resources, and information. This kind of connection mode between the two nodes is referred to as “tight coupling”.

A SAN is configured from an FC switch. Each server 10A, 10B comprises path control software 102A (102B) for controlling the path to and from the storage apparatus, and a path route management table 100A.

Since the first storage apparatus 12A and the second storage apparatus 12B adopt the same configuration, the explanation of the first storage apparatus shall also apply as the explanation of the second storage apparatus. Note that the same reference numeral is given to the same constituent element of the second storage apparatus as the constituent element of the first storage apparatus, but the constituent elements are distinguished by adding “A” to the reference numeral of the constituent element of the former, and by adding “B” to the reference numeral of the constituent element of the latter.

The storage apparatus 10A basically comprises a storage device group 36A configuring the storage resource, and a storage controller for controlling the data transfer between the servers 10A, 10B and the storage device group 36A. A plurality of control packages configuring the storage controller have an internal bus architecture of a personal computer such as a PCI, and is preferably connected mutually via a bus which realizes high-speed serial data transfer protocol as with a PCI Express.

The frontend of the storage controller has a plurality of channel adapter packages (CHA-PK) 16A-1 . . . 16A-N (N is an integer of 2 or higher) respectively corresponding to a host interface. Each CHA-PK comprises an interface (I/F) for connecting with the SAN, and a local router (LR) for converting the fibre channel as the data protocol of the server 10 into an interface of PCI Express (PCI-Ex) and routing the I/O from the server. A local memory (not shown) of the CHA-PK stores data from the server, and a routing table (described later) for deciding the MP to be in charge of the processing of commands.

The backend of the storage controller has a disk adapter package (DKA-PK) 28A for connecting with the respective storage devices 34A of the storage device group 36A. A representative example of a storage device is a hard disk drive, but it may also be a semiconductor memory such as a flash memory.

The DKA-PK 28A comprises, as with the CHA-PK 16A, a protocol chip for converting the protocol of data of the storage device 34A and the PCI-Ex interface, and a local router for routing data and commands.

The storage controller additionally comprises a cache memory package (CM-PK) 30A for buffering data that is exchanged between the server 10 and the storage device 34A, a microprocessor package (MP-PK) 26A for performing instruction/arithmetic processing, and an expansion switch (ESW) 18A for switching the exchange of data and commands among the CHA-PK 16A, the DKA-PK 28A, the CM-PK 30A and the MP-PK 26A.

The ESW 18A of the first storage apparatus 12A and the ESW 18B of the second storage apparatus 12B are connected, as described above, with the dedicated bus 20 configured from an interface such as PCI Express. The MP-PK 26A comprises an MP and a local memory (LM). Control resources such as the CHA, the DKA, the CM, the MP and the ESW are packaged as described above, and the packages may be increased or decreased according to the usage condition or request of the user.

The ESW 18A is connected to a management computer (SVP 1) 22A. The SVP 1 (22A) is a service processor that is built into the storage apparatus for managing the overall storage apparatus. The SVP program running on the SVP executes the management function of the storage apparatus and manages the control information. A management terminal 14 is connected to the SVP 1 via the management interface of the storage apparatus 12A, and the management terminal 14 comprises an input device for inputting management information into the SVP 1, and an output device for outputting management information from the SVP 1.

The storage area of the plurality of storage devices 34A is logicalized as a RAID group, and the LDEV is set as a result of partitioning the logicalized storage area.

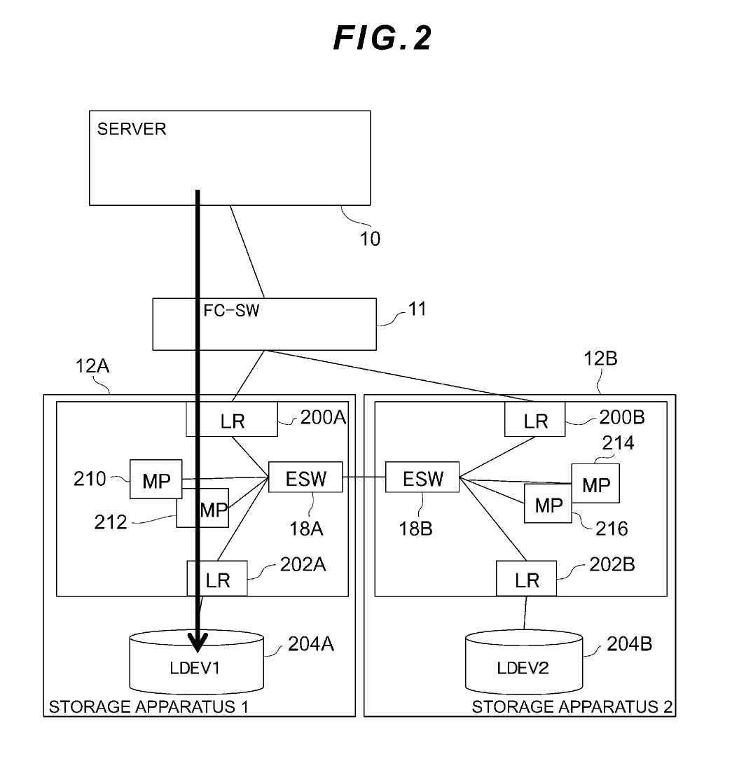

The plurality of modes of the flow of I/O of data and commands from the server 10 to the LDEV of the first storage apparatus 12A are now explained with reference to the drawings. FIG. 2 shows the first mode, and the I/O from the server 10 to the LDEV 1 (204A) is being processed by the MP (MP-PK) 212 of the first storage apparatus 12A. Even in cases where the load of the MP 212 exceeds a predetermined range, so as long as the load of the MPs 210 is within the predetermined range, the storage apparatus 12A continues the I/O processing by switching the owner right of the MP 212 for accessing the LDEV 1 to the MP 210. 204A (204B) of FIG. 2 is the local router (LR) of the DKA-PK 28A (28B).

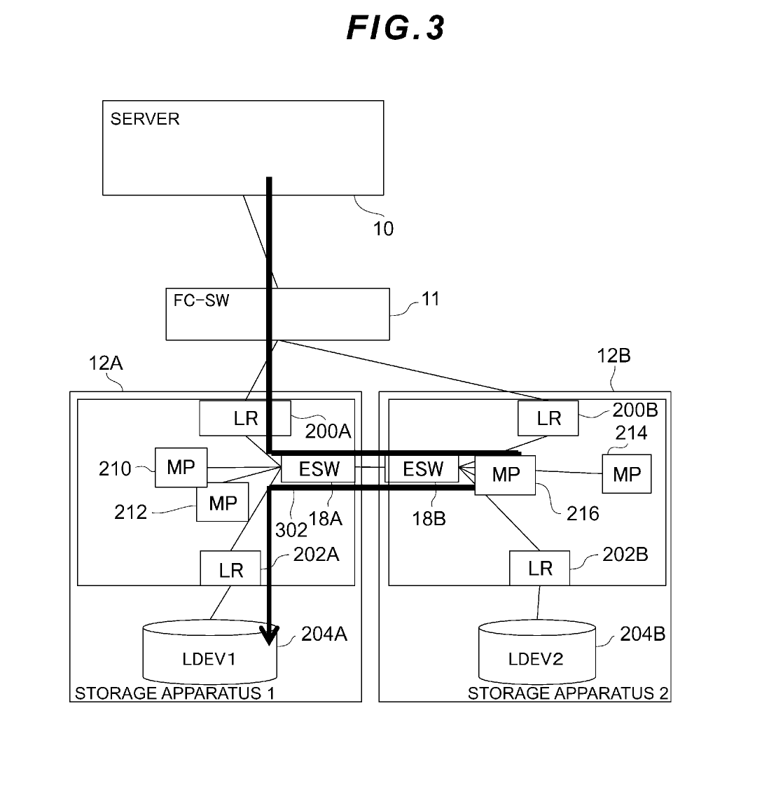

Meanwhile, in the second mode, as shown in FIG. 3, if every load of the plurality of MPs of the first storage apparatus 12A is higher than a predetermined value, the first storage apparatus 12A migrates the owner right for accessing the LDEV 1 to the MP of the second storage apparatus. FIG. 3 shows that the owner right for accessing the LDEV 1 has been migrated to the MP 216 of the second storage apparatus 12B.

In FIG. 3, when the LR 200A of the first storage apparatus 12A receives an I/O from the server 10 to the LDEV 1, it routes the I/O to the MP 216 of the second storage apparatus via the dedicated bus 20 between the ESW 18A and the ESW 18B (300). Subsequently, the MP 216 processes the I/O by accessing the LDEV 1 of the first storage apparatus 12A via the dedicated bus 20 (302). The computer system is thereby able to balance the load of the MPs between the plurality of storage apparatuses 12A, 12B.

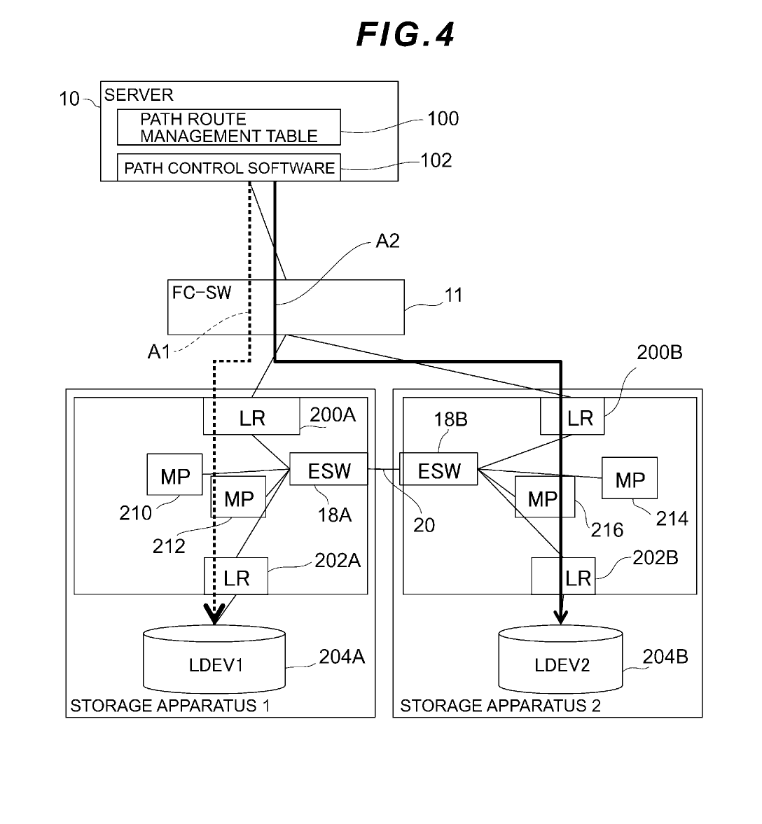

With the mode shown in FIG. 3, there is a possibility that overhead will arise in the I/O transfer with the bus 20 between the storage apparatuses and the I/O performance will deteriorate. Thus, as shown in FIG. 4, when the first storage apparatus 12A detects that the owner right for accessing the LDEV 1 has been switched to the MP of the second storage apparatus 12A, it volume-copies data of the LDEV 1 to be accessed by the server to the LDEV 2 (204B) of the second storage apparatus, and the management computer additionally switches the path (A1) between the server 10 and the LDEV 1 to the path (A2) to and from the LDEV 2 of the second storage apparatus 12B. The MP 216 of the second storage apparatus is thereby able to apply the I/O from the server 10 to the LDEV 2 of the self-case without going through the bus 20 between the cases.

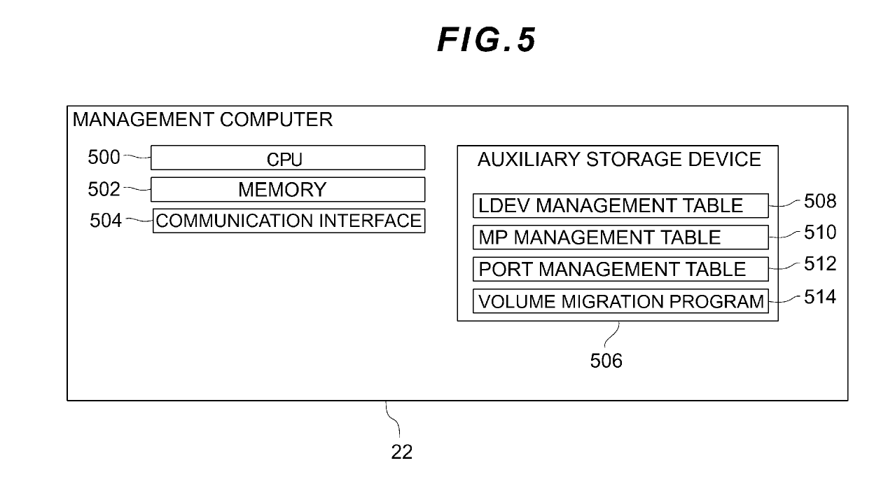

FIG. 5 is a functional block diagram of the SVP 22A, 22B, and the SVP includes a CPU 500 for executing the management function, a memory 502 which records data required for executing the management function, an interface 504 for communicating with the management terminal 14 and the ESW 18A, and an auxiliary storage device 506. The auxiliary storage device 506 stores an LDEV management table 508, an MP management table 510, a port management table 512, and a volume migration program 514. The SVP 1 (22A) and the SVP 2 (22B) have a table with the same subject matter as a result of communicating the management information via the dedicated bus 20.

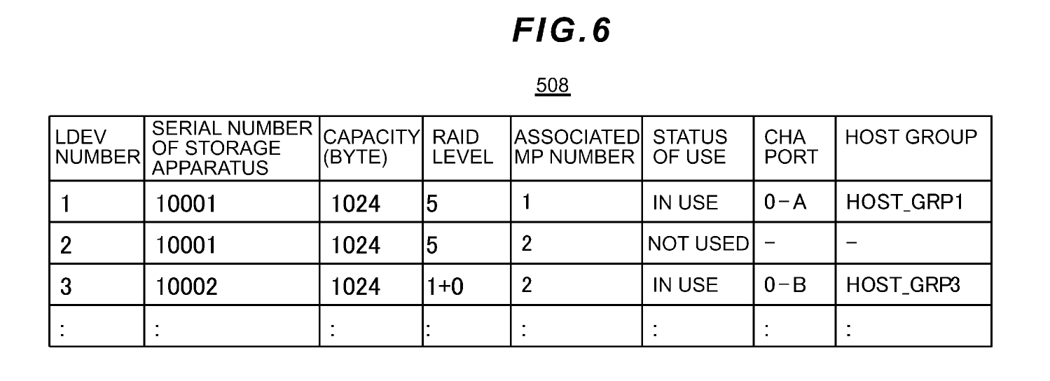

FIG. 6 shows an example of the LDEV management table 508. The LDEV management table is used for managing the configuration information and status of use of the LDEV, and includes an LDEV (identification) number, serial number of the storage apparatus to which the LDEV belongs, LDEV capacity, RAID level of the RAID group configuring the LDEV, (identification) number of the associated MP with the processing authority of the LDEV, information concerning the status of use showing whether the LDEV has been set and is being used as the access destination of the server, port (number) of the CHA to which the logical path to and from the LDEV is set, and a record of the identification number of the host group configured from one or more host apparatuses capable of accessing the LDEV.

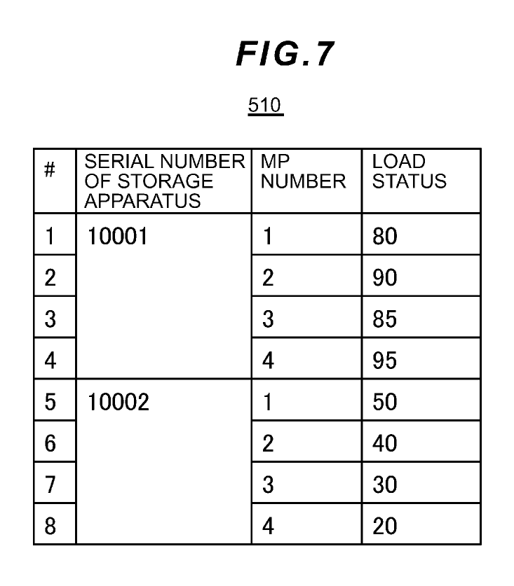

FIG. 7 shows the MP management table 510. The MP management table is used for managing the processor (MP-PK) 26A (26B) of the storage apparatus, and comprises, for each serial number of the storage apparatus, an identification number of the MP and a record of the load status of the respective MPs. The load status is shown as IOPS (IO/per second).

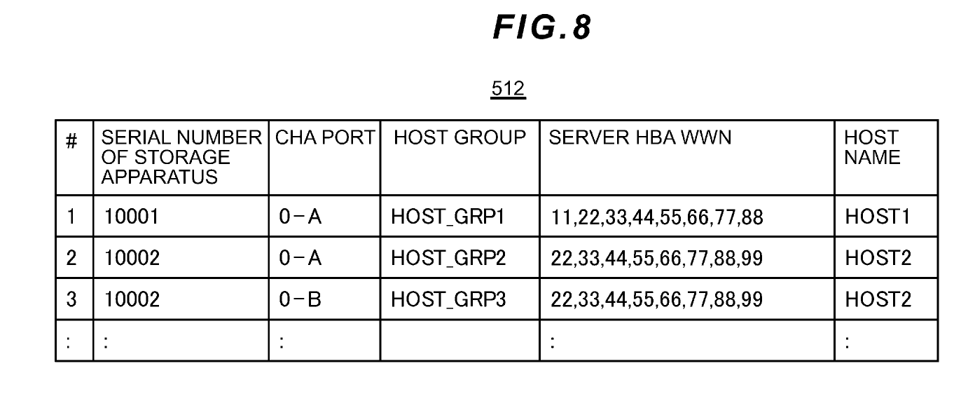

FIG. 8 shows an example of the port management table 512. The port management table is a table for managing the connection information of the ports of the CHA 16A, 16B of the storage apparatus and the ports of the server, and includes, for each serial number of the storage apparatus, an identification number of the CHA port, identification information of the host group connected to the CHA port, WWN (World Wide Name) of the HBA of the server 10A, 10B, and a record of the host name connected to the CHA port.

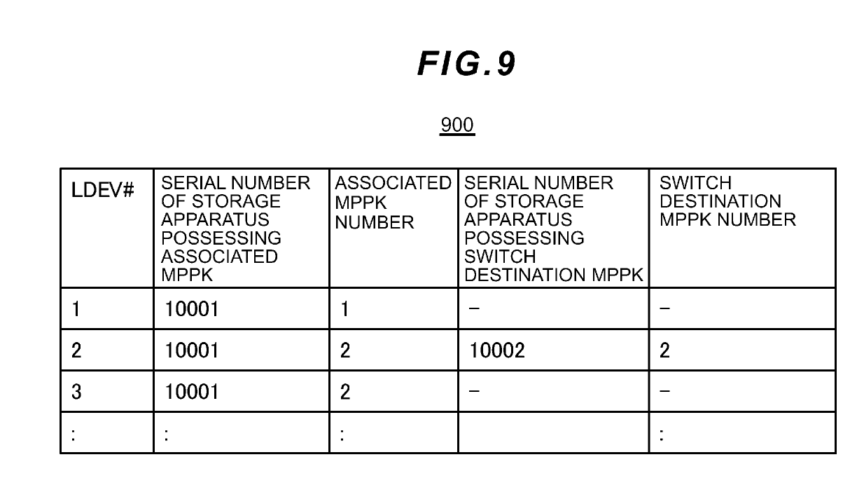

FIG. 9 shows an example of the mapping table 900 recorded in the local memory of the CHA. This mapping table is a table for managing the owner right of the MP for accessing the LDEV, and the LR of the CHA 16A, 16B refers to the mapping table and decides the MP to be in charge of the processing of the I/O from the host computer to be performed to the LDEV, and maps the associated MP to the I/O processing.

The mapping table comprises the respective records of an LDEV identification number (#), serial number of the storage apparatus including the MP-PK 26A (26B) in charge of performing the I/O processing to the LDEV, (identification) number f the associated MP-PK, serial number of the storage apparatus including the transfer destination MP-PK to which the owner right for accessing the LDEV is to be transferred, and the (identification) number of the transfer destination MP-PK.

According to the mapping table of FIG. 9, the owner right for accessing the LDEV of the MP-PK of number [2] in the storage apparatus with the serial number [10001] has been switched to the MP-PK of number [2] in the storage apparatus with the serial number [10002].

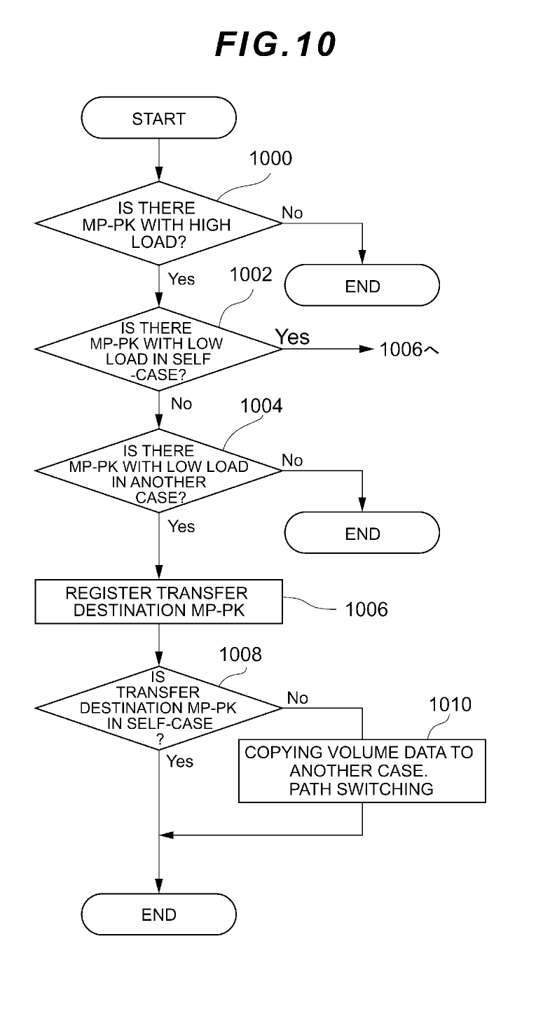

The SVP 1 (22A) checks the load of the respective MP-PKs 26A, 26B of the first storage apparatus 12A and the second storage apparatus 12B, and updates the MP management table 510 by incorporating the check results. In addition, the SVP 1 performs the MP routing control processing. FIG. 10 is a flowchart of the routing control processing. The SVP 1 refers to the MP management table 510 according to a predetermined schedule, and checks whether there is an MP (MP-PK) with a high load (Step 1000). The SVP 1 determines an MP-PK with a load exceeding a predetermined threshold (S1) as being in a high load state.

If the SVP 1 obtains a negative determination at step 1000, the flowchart is ended, and, if a positive result is obtained in the foregoing determination, it checks whether there is an MP-PK with a low load in the self-case (Step 1002). The SVP 1 determines an MP-PK with a load that is below a predetermined threshold (S2) as being in a low load state. Note that threshold (S1) equal or more than threshold (S2).

If the SVP 1 obtains a positive determination at step 1002, it proceeds to step 1006 described later. Meanwhile, if a negative result is obtained in the foregoing determination at step 1002, the SVP 1 determines whether an MP-PK with a low load exists in another case (Step 1004). If a negative result is obtained in the foregoing determination, the flowchart is ended since it is determined that there is no MP-PK with a low load in the self-case and other cases to which the owner right of the high load MP-PK for accessing the LDEV 1 (204A) can be switched. Meanwhile, if a positive result is obtained in the foregoing determination, the SVP 1 proceeds to step 1006.

At step 1006, the SVP 1 decides another MP-PK to which the owner right of a high load state MP-PK should be transferred, and updates the mapping table 900 of the CHA 16A of the first storage apparatus 12A and the CHA 16B of the second storage apparatus 12B through registration. If there are a plurality of low load MP-PKs in the self-case (first storage apparatus 12A) or another case (second storage apparatus 12B), at step 1002 or step 1004, the SVP 1 decides the MP-PK with the smallest load as the transfer destination. Note that one MP-PK may possess the owner right for accessing a plurality of LDEVs. When the transfer source MP-PK becomes a low load, the owner right may or may not be returned from the transfer destination MP-PK to the transfer source MP-PK. Furthermore, the owner right for accessing the LDEV may be set in a plurality of MPs.

Subsequently, the SVP 1 checks whether the transfer destination MP-PK is in the self-case based on the MP management table 510 (Step 1008), and ends the flowchart upon obtaining a positive determination, and proceeds to step 1010 upon obtaining a negative determination. At step 1010, the SVP 1 executes processing for copying the volume data of the LDEV 1 to be accessed by the server to another case, and the path switching from the server to the copy destination LDEV 2. The foregoing processing is executed according to the flowchart described later. Note that the copy processing and the path switch processing may be executed by the SVP 2. In the ensuing explanation, the copy source volume in the first storage apparatus 12A is referred to as the LDEV 1 and the copy destination volume in the second storage apparatus 12B is referred to as the LDEV 2. Note that, although the SVP is executing the respective processing steps in the flowchart of FIG. 10, the configuration is not limited thereto, and the processing steps may also be executed by the MP-PK or the like.

When the LR of the CHA 16A receives an I/O to be performed to the LDEV 1 from the server 10A, 10B, it refers to the mapping table 900, determines the associated MP-PK as the I/O routing destination, and transfers the I/O to the associated MP-PK. When the owner right for accessing the LDEV 1 is migrated to an MP-PK of another case, the I/O of the server has been supplied to the second storage apparatus 12B based on the path switching, and the LR of the CHA 16B that received the I/O to be performed to the LDEV 1 refers to the mapping table 900 and determines the associated MP-PK (transfer destination MP-PK). The associated MP-PK refers to the LDEV management table 508 and processes the I/O from the server to the LDEV 2 (copy volume of LDEV 1) for which it owns the owner right thereof.

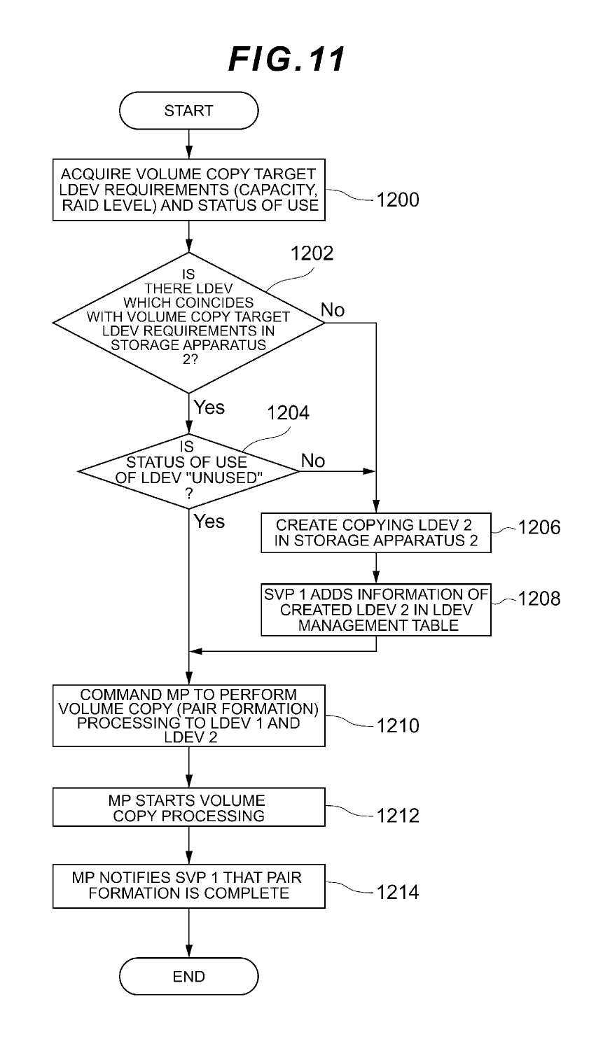

FIG. 11 is a detailed flowchart of the volume copy processing. FIG. 11 shows the volume copy processing that is executed at step 1010 of FIG. 10. The SVP 1 acquires management information (configuration information (capacity, RAID level) and status of use) of the copy source LDEV (LDEV 1) from the LDEV management table 508 (step 1200). The SVP 1 determines whether the second storage apparatus 12B has an LDEV which coincided with the configuration information of the volume copy source LDEV (step 1202). If a positive result is obtained in the foregoing determination, the SVP 1 determines whether the status of use of the relevant LDEV is unused (step 1204).

If the SVP 1 determines that the status of use of the LDEV is unused, the SVP 1 registers the volume copy source LDEV (LDEV 1) and the volume copy destination LDEV (LDEV 2) as a copy pair in the pair management table stored in the local memory, and commands the associated MP-PK of the LDEV 1 or another MP-PK to volume-copy the volume data of the LDEV 1 to the LDEV 2 (step 1210). The MP (MP-PK) that received the foregoing command starts the volume copy (step 1212), and, when the LDEV 2 is synched with the LDEV 1 after the volume copy is complete, the MP-PK notifies the SVP 1 that the pair formation is complete (step 1214). The SVP 1 thereafter splits the LDEV 1 and the LDEV 2.

The MP stores the difference data from the server 10A, 10B in the CM-PK 30A or the CM-PK 30B from the start to end of the pair formation processing. Among the logical block addresses of the LDEV 1, the area in which the copy is complete is managed with a bitmap. The area which is updated based on the I/O from the server is similarly managed with a bitmap. After the pair formation is complete, the MP-PK reflects the difference data in the copy destination volume (LDEV 2) based on the bitmap. The MP registers, in the LDEV management table 508, the identification number of the transfer destination MP-PK of the mapping table 900 as the associated MP (MP-PK) of the copy destination volume LDEV 2.

If a negative result is obtained in the determination at step 1202, the SVP 1 creates a new LDEV (LDEV 2) as a copying volume of the LDEV 1 in the second storage apparatus 12B containing the transfer destination MP (step 1206). Subsequently, the SVP 1 adds and registers the information of the created LDEV 2 in the LDEV management table 508 (step 1208), and then proceeds to step 1210.

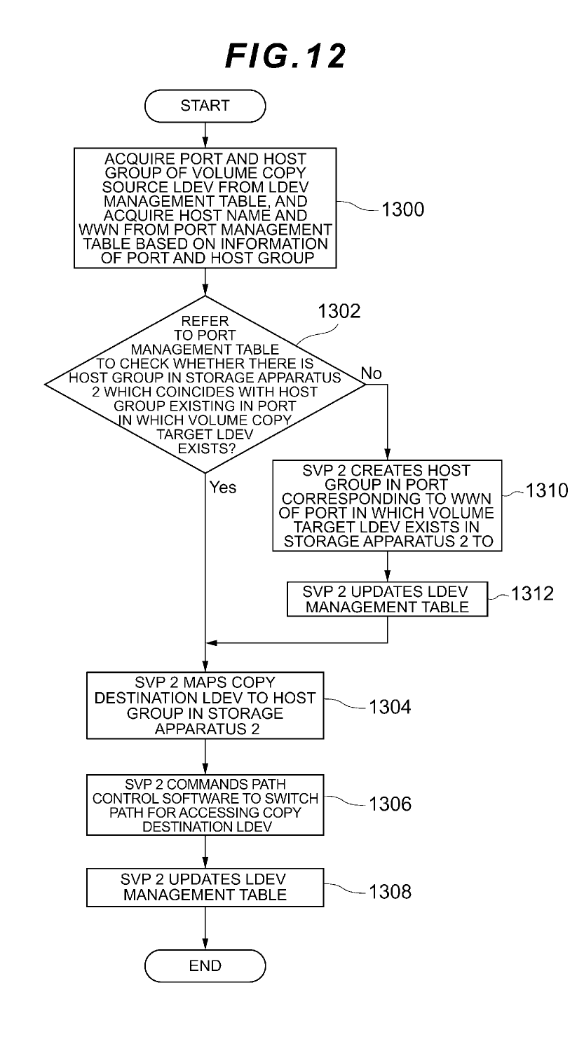

The path change processing that is executed at step 1010 of FIG. 10 is now explained. FIG. 12 is a flowchart of the path change processing. When the SVP 2 receives a volume copy completion notice from the SVP 1, it acquires information of the port of the volume copy source LDEV 1 from the LDEV management table 508 and information of the corresponding host group (host group 1), and additionally acquires the host name and the server HBA WWN from the port management table 512 based on the information of the port and the host group (step 1300).

Subsequently, the SVP 2 refers to the port management table 512, and determines whether a host group that coincides with the host group 1 at step 1300 exists among the host groups existing in the second storage apparatus 12B with the LDEV 2 as the synchronized volume of the LDEV 1 (step 1302).

If the SVP 2 obtains a positive result in the foregoing determination, it maps the volume copy destination LDEV 2 to the relevant host group (step 1304), commands the path control software 102A or 102B of the access source host (server) of the volume copy source LDEV (LDEV 1) of the foregoing host group to switch the path for accessing the LDEV 2 (step 1306), and further updates the LDEV management table 508 (step 1308).

Meanwhile, if a negative result is obtained in the determination at step 1302, the SVP 2 creates a new host group which coincides with the host group 1 in the port of the CHA in which the server HBA WWN corresponding to the volume copy target source LDEV 1 is to be connected to the second storage apparatus 12B (step 1310), updates the port management table 512 by registering this therein (step 1312), and thereafter proceeds to step 1304.

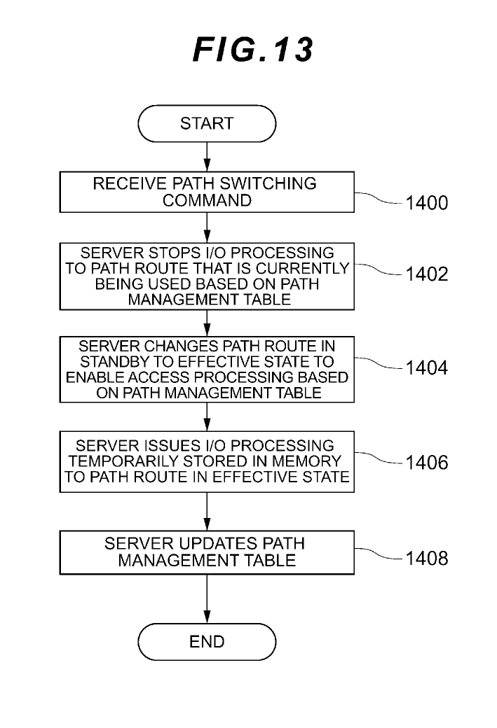

FIG. 13 is a flowchart of the path control software 102A, 102B of the server 10A, 10B. When the path control software receives a path switch command from the SVP 2 (FIG. 12: step 1306) (step 1400), the server that received the path switch command refers to the path management table (described later), and stops the I/O of the path route that is being currently used (step 1402). The server temporarily stores the commands and data associated with the I/O to the stopped path in the memory of the server.

Subsequently, the server refers to the path management table, determines a path route in a standby state to which the LDEV 2 as the volume copy destination can be connected, and changes the status of the path route from a standby state to an effective state (operating state) so that the issue of the I/O from the server to the path route in a standby state is enabled (step 1402). Here, the path route in a standby state is created based on step 1310 and step 1312 of FIG. 12. Subsequently, the server issues an unprocessed I/O that was temporarily stored in the memory to the path route which was changed to an effective state (step 1406), and updates the path management table (step 1408).

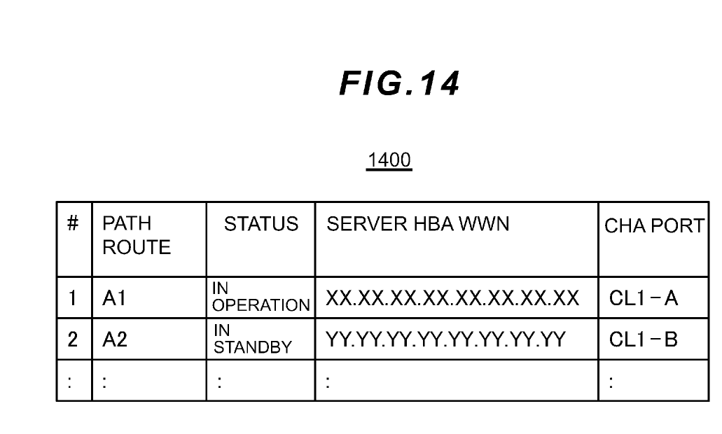

FIG. 14 shows the path management table 1400 which includes the following records; namely, a path route status for each path route, server HBA WWN, and identification number of the CHA port. Note that, when the SVP 2 creates a new path at step 1310 and step 1312 of FIG. 12, it registers this path as in standby in the path management table 1400.

According to the embodiment explained above, as shown in FIG. 4, even if the processing authority of the host computer for accessing the access destination logical volume is transferred to a processor of a storage apparatus in a case that is different from the case containing the logical volume, the processor to which the authority was transferred is able to process the I/O of the host computer by accessing the logical volume of the self-case, and, therefore, it is possible to migrate the processing authority for accessing a logical volume between a plurality of storage apparatuses without causing any overhead in the performance of the path between the plurality of storage apparatuses.

The second embodiment of the present invention is now explained. This embodiment is characterized in that a management server for executing the management processing to the business server 10A, 10B has been provided to the foregoing first embodiment. The management server determines whether it is necessary to copy the LDEV upon migrating the owner right for accessing the LDEV to an MP of another storage apparatus.

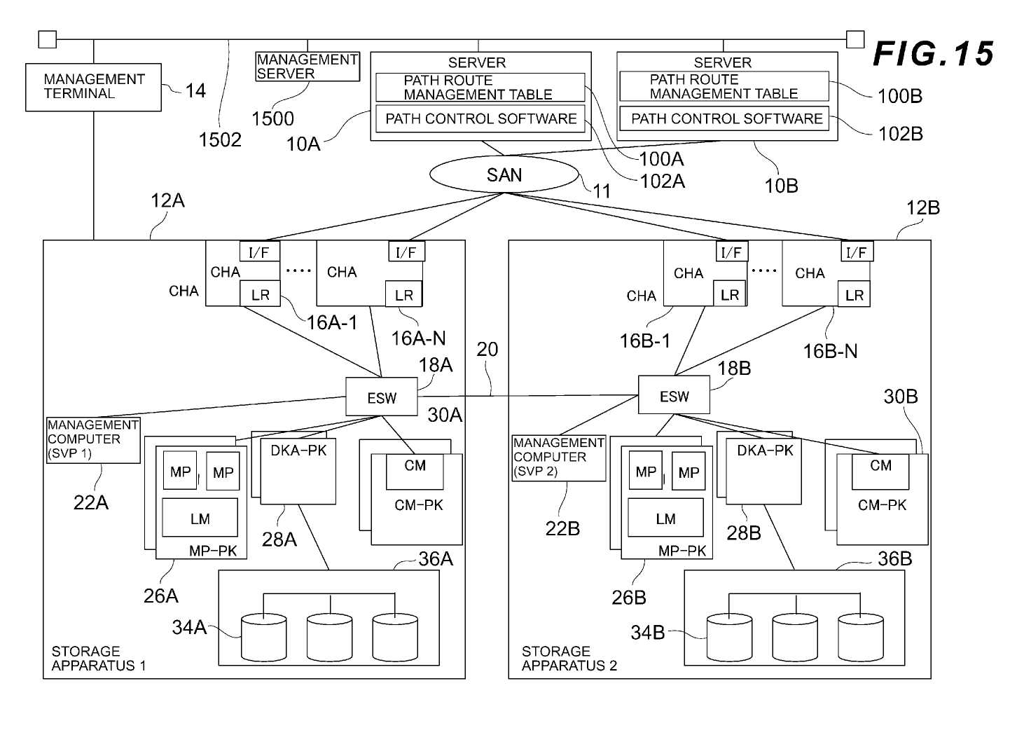

FIG. 15 is a block diagram of the computer system according to the second embodiment, and a management server 1500 is connected to the business servers 10A, 10B via a LAN 1502. The management terminal 14 is connected to the LAN 1502. The management server 1500 acquires performance information concerning the I/O processing that is measured with the business servers 10A, 10B upon the owner right for accessing the LDEV 1 is switched from the MP of the first storage apparatus 12A to the MP of the second storage apparatus 12B, and, when the acquired performance information does not satisfy the requirements of the application that is being executed by the business server, performs the volume data copy processing and path change processing of the access destination volume (LDEV 1) of the business server. The business server measures the I/O performance based on the response of the storage apparatus to the I/O issued by the storage apparatus. The I/O performance includes a response time in addition to IOPS.

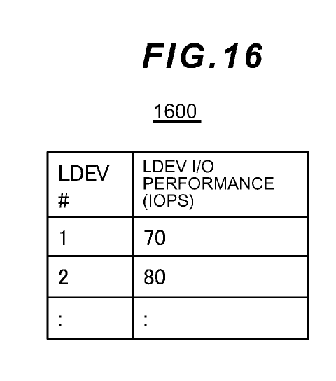

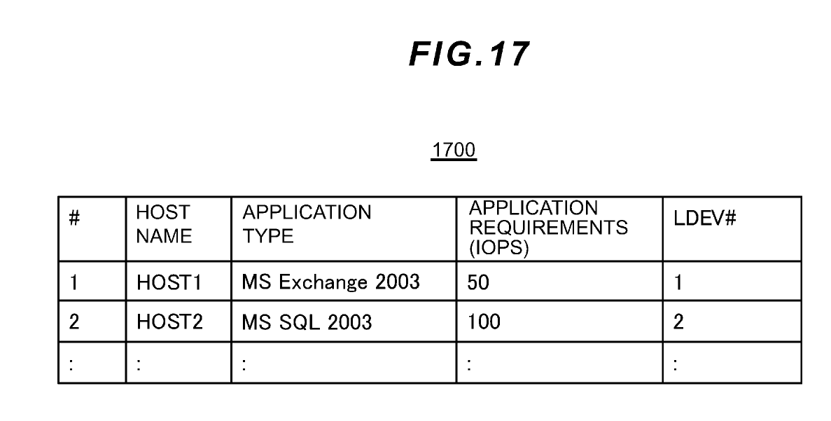

The management server 1500 therefore comprises an LDEV performance information table 1600 (FIG. 16) for managing the I/O performance to the LDEV of the business server, a requirement table 1700 (FIG. 17) which sets forth the requirements of the I/O performance in the application, and a volume migration management program.

The LDEV performance information table 1600 of FIG. 16 comprises the following records; namely, an LDEV identification number, and I/O performance for each LDEV. The I/O performance requirement table 1700 of FIG. 17 includes the following records; namely, a server name (host name), type of application that is loaded in the server, processing performance (IOPS) of the I/O from the storage apparatus required by the application, and identification number of the LDEV that is being used by the application. According to the type of application, the requirement items of the I/O performance requirement table may be increased or decreased.

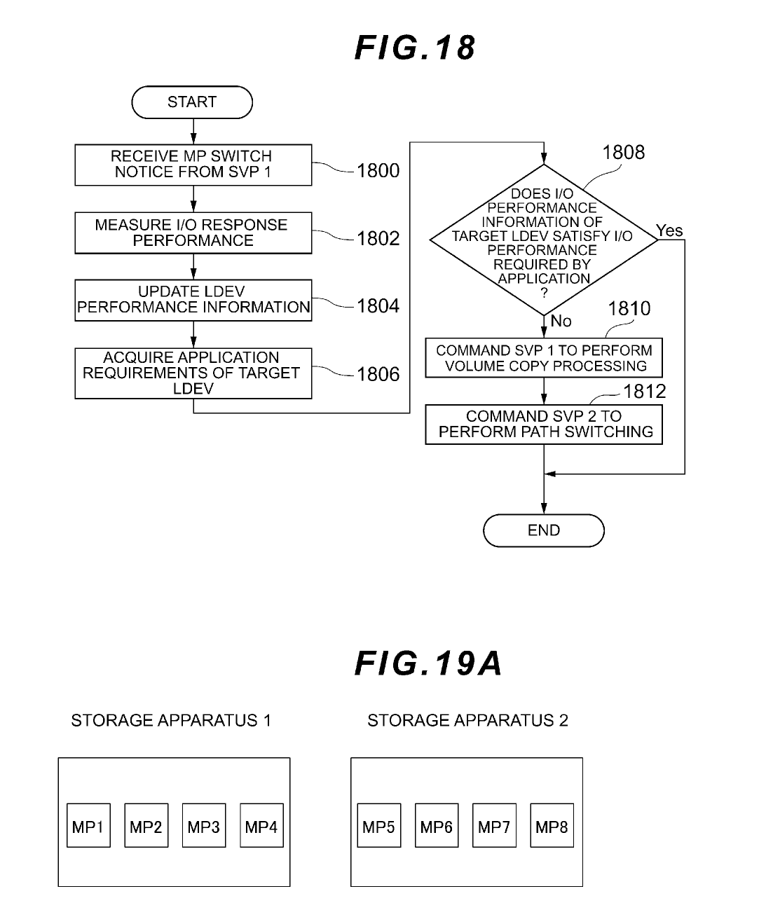

FIG. 18 is a flowchart of the volume migration management program to be executed by the management server 1500. Foremost, the management server 1500 receives, from the SVP 1, a notice to the effect that the owner right for accessing the LDEV has been switched to an MP (MP-PK) of the second storage apparatus (step 1800). In other words, when transferring the owner right for accessing the LDEV to another MP-PK as a result of the MP-PK in the self-case becoming a high load, a notice to the effect that the transfer destination MP-PK is in another case is received. The SVP 1 refers to the LDEV management table 508 and determines the CHA port number and the host group number corresponding to the target LDEV (LDEV 1), and additionally refers to the port management table 512 and determines the server HBA WWN and the host name, and notifies the foregoing information to the management server 1500.

The management server 1500 accesses the business servers 10A, 10B based on the information notified from the SVP 1, and acquires the response performance information of the I/O to the target LDEV from the business server (step 1802). Note that, although the I/O response performance was acquired in this embodiment, the configuration is not limited thereto so as long as it is a value that shows the access performance to the target LDEV. Subsequently, the management server updates the LDEV performance information table 1600 based on the acquired information (step 1804). Moreover, the management server refers to the application requirement table 1700 and acquires the required performance of the application corresponding to the target LDEV (step 1806), and compares the acquired required performance and the I/O performance of the business server to the target LDEV (step 1808).

If the I/O performance of the business server is equal to or less than the required performance, the management server commands the SVP 1 to copy the volume data of the target LDEV to the LDEV of the second storage apparatus (step 1812). When the SVP 1 receives the foregoing notice, it refers to the volume pair management table and determines the copy destination volume (LDEV 2) of the second storage apparatus 12B in a pair relationship with the target LDEV (LDEV 1), and implements the volume copy from the LDEV 1 to the LDEV 2. Subsequently, the management server commands the SVP 2 to switch the path to the volume copy destination LDEV 2 (step 1812), and the SVP 2 thereby performs the path change processing. Note that the volume copy processing and the path switch processing are executed based on the processing shown in FIG. 11 to FIG. 13.

Meanwhile, if the I/O performance of the business server is greater than the required performance at step 1808, the business server does not perform the volume copy processing and the path switch processing. Specifically, as shown in FIG. 3, even if the MP to which the owner right for accessing the LDEV has been transferred goes through a bus between cases of a plurality of storage apparatuses, so as long as it is able to satisfy the I/O performance that is required by the server, it would be more effective to omit the volume copy and path switch processing from the perspective of power saving in the processing to be performed by the storage apparatus.

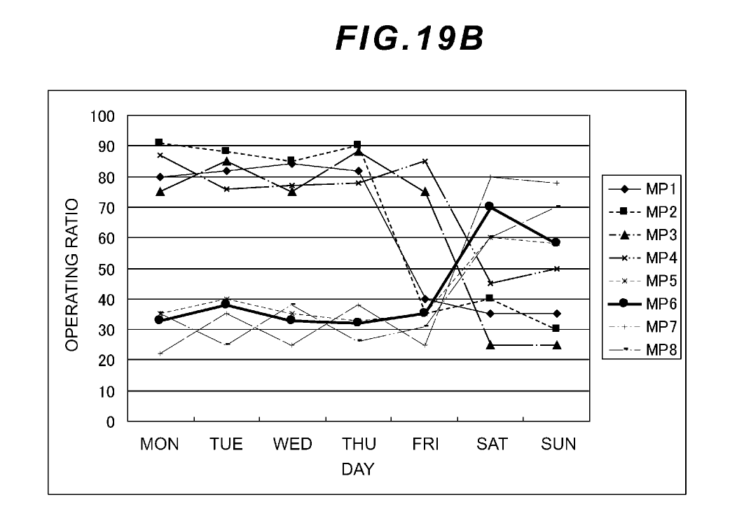

The third embodiment is now explained. In this embodiment, the SVP or the management server collects the history of the operating ratio and volume copy of the MP, and enables a maintenance worker to design a schedule of volume copy based on the results of the collection. FIG. 19A is a block diagram of a plurality of MPs in the first storage apparatus 12A and the second storage apparatus 12B, and FIG. 19B is a graph showing the fluctuation of the (weekly) operating ratio of the respective MPs.

Let it be assumed that the operating ratio of the MPs 1 to 4 of the storage apparatus 1 and the MPs 5 to 8 of the storage apparatus 2 is as shown in the graph. When this operating ratio is statistically analyzed, for example, let it be assumed that the following tendency has been discovered. When focusing on a certain application, access to the LDEV 1 is routed to the MP 1 of the storage apparatus 1 during the period from Monday to Friday, and the owner right of the MP 1 is switched to the MP 5 of the storage apparatus 2 during the period from Saturday to Sunday. On Monday, the owner right of the MP 5 is switched to the MP 1 of the storage apparatus 1.

On the assumption that this kind of cycle is repeated, when the SVP or the like implements the volume copy processing from the LDEV 1 to the LDEV 2 from Friday to Saturday, the LDEV 1 is designated as the volume copy destination upon implementing the volume copy processing once again from the LDEV 2 to the LDEV 1 from Sunday to Monday without deleting the copy source LDEV 1. As a result of adopting the foregoing configuration, the load required for volume copy can be alleviated since the copy from the LDEV 2 to the LDEV 1 can be completed based on the difference. In addition, on the assumption that the copy destination volume is set on a case-by-case basis, there is a possibility that a difference may arise in the volume performance based on the performance difference of the hard disk drive to which the LDEV is set. Meanwhile, in the case where the copy source volume is not deleted, there is no such possibility.

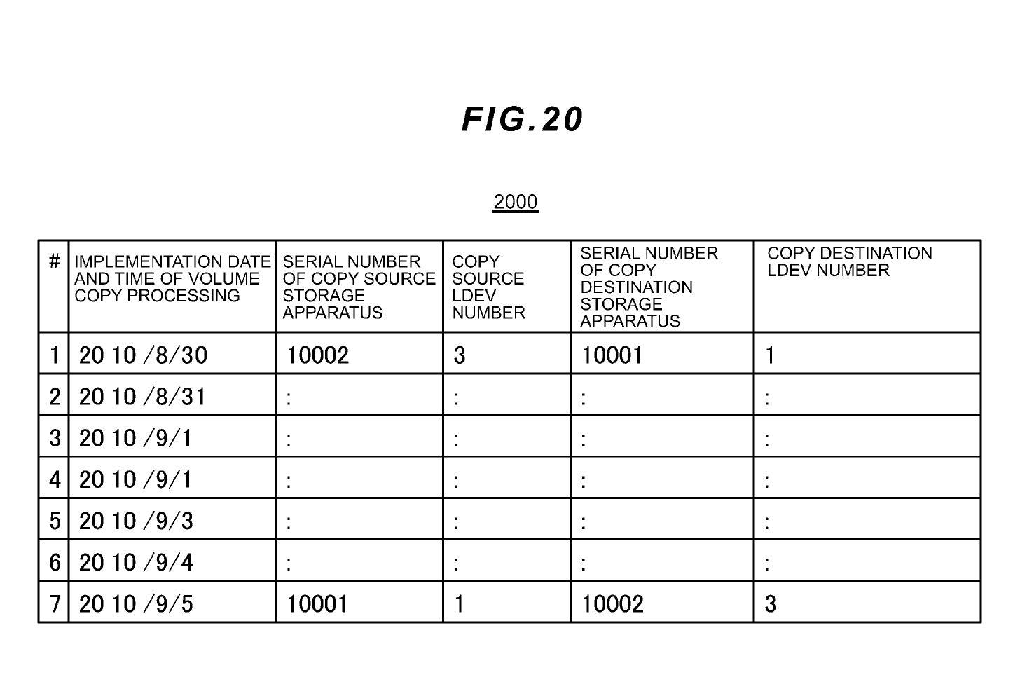

FIG. 20 is a table for managing the implementation history of volume copy. This table is stored, for example, in the SVP (SVP 1, SVP 2) or the management server. The management table is used upon selecting the copy destination LDEV when the SVP or the like is to perform volume copy. The implementation history is recorded for a seven-day period.

### REFERENCE SIGNS LIST

10A, 10B Business server (host computer)
12A First storage apparatus
12B Second storage apparatus
26A, 26B MP-PK
16A, 16B CHA-PK (host interface)
20 Dedicated bus between storage apparatuses
22A, 22B SVP (management computer)
1500 Management server (management computer)

1. A computer system, comprising:
a first storage apparatus for providing a first volume to a host computer;
a second storage apparatus including a second volume and connected to the first storage apparatus; and
a management computer,
wherein the management computer:
switches, according to a load status of a first processor of the first storage apparatus, processing authority of the first processor for accessing the first volume to a second processor of the second storage apparatus; and
copies data of the first volume to the second volume upon performing the switch, and
wherein the second processor receives access from the host computer via a port of a host interface of the second storage apparatus, and processes the access to the second volume to which data of the first volume was copied.

2. The computer system according to claim 1,
wherein the first storage apparatus and the second storage apparatus are subject to tight coupling with a bus configured from a dedicated interface.

3. The computer system according to claim 1,
wherein the management computer:
copies data of the first volume to the second volume after the switch; and
forms a path to and from the host computer in the port when the copy is complete, and
wherein the second processor receives the access via the path.

4. The computer system according to claim 1,
wherein the management computer:
copies data of the first volume to the second volume after the switch; and
switches the path to and from the host computer from the port of the host interface of the first storage apparatus to the port of the second storage apparatus when the copy is complete, and
wherein the second processor receives the access via the port of the second storage apparatus.

5. The computer system according to claim 1,
wherein the management computer:
acquires access processing performance of the host computer from that host computer after processing authority for accessing the first volume is switched from the first processor to the second processor; and
copies data of the first volume to the second volume according to the acquired performance information.

6. The computer system according to claim 5,
wherein the management computer copies data of the first volume to the second volume if the performance information exceeds a threshold.

7. The computer system according to claim 6,
wherein the management computer does not copy data of the first volume to the second volume if the performance information is below the threshold, and
wherein the second processor receives the access via a bus between the first storage apparatus and the second storage apparatus, and additionally executes processing of the access to the first volume via the bus.

8. The computer system according to claim 5,
wherein the access processing performance is set forth each type of software that is run by the host computer.

9. The computer system according to claim 1,
wherein the first storage apparatus and the second storage apparatus are subject to tight coupling with a bus configured from a dedicated interface,
wherein the management computer:
acquires access processing performance of the host computer from that host computer after processing authority for accessing the first volume is switched from the first processor to the second processor of the second storage apparatus;
copies data of the first volume to the second volume if the performance information exceeds a threshold, switches the path to and from the host computer from the port of the host interface of the first storage apparatus to the port of the second storage apparatus when the copy is complete, and causes the second processor to process the access to the second volume by supplying the access from the host computer to the second processor via a port of the second storage apparatus; and
does not copy data of the first volume to the second volume if the performance information is below the threshold, and, in this case, the second processor receives the access via a bus between the first storage apparatus and the second storage apparatus, and additionally executes processing of the access to the first volume via the bus.

10. A control method of a computer system including a plurality of storage apparatuses and a management computer,
wherein, upon migrating processing authority of a processor for accessing a logical volume to be accessed by a host computer between the plurality of storage apparatuses, the management computer copies data of a logical volume of a migration source storage apparatus to a logical volume of a migration destination storage apparatus, and changes a path to and from the host computer from the migration source storage apparatus to the migration destination storage apparatus.
